(19) United States
(12) Patent Application Publication
(10) Pub. No.: US 2014/0334867 A1
(43) Pub. Date: Nov. 13, 2014

(54) PIVOT JOINT FOR A STROLLER FRAME

(71) Applicant: LERADO (ZHONG SHAN) INDUSTRIAL CO., LTD., Zhong Shan City (CN)

(72) Inventors: JIA-HONG SU, BEIGANG TOWNSHIP (TW); HSIN-FU CHENG, CHIAYI CITY (TW)

(21) Appl. No.: 14/273,907

(22) Filed: May 9, 2014

(30) Foreign Application Priority Data
May 9, 2013 (CN) 201320247281.1

(51) Int. Cl. B62B 7/10; F16C 11/10

(52) U.S. Cl. CPC B62B 7/10; F16C 11/10
USPC 403/106

(57) ABSTRACT

A pivot joint can lockably pivot a front struts, a rear struts and a push arms on each side of a stroller. The pivot joint includes a pivot mount, a first driving plate, a second driving plate and a locking mechanism. A release mechanism is adopted to associate between the locking mechanisms of the two pivot joints for unlocking the locking mechanisms simultaneously. Once the two pivot joints are unlocked by the release mechanism, the stroller frame can be safely folded into a folded configuration by depressing the push arm downward. While the push arm is rotating downward, the pivot joint shall make the front strut to rotate rearward to close the rear strut automatically.

### BACKGROUND OF THE INVENTION

1. Field of the Invention

The present invention relates a pivot joint, especially to a pivot joint may be mounted on either side of a stroller frame, and can be manipulated by merely with one hand.

2. Description of the Related Art

Traditional four-bar linkage foldable stroller is bulky and difficult to reduce the weight by new structure design. Therefore it is also hard to cost-down and simply the process for manufacture of the stroller.

### SUMMARY OF THE INVENTION

For reducing the weight and cost-down the manufacture of the stroller, the present invention provides a pivot joint for a stroller frame. The stroller frame has a left side and a right side each comprising a front strut connected at least a front wheel, a rear strut connected a pair of rear wheels and a push arm. The front strut, rear strut and the push arm of each side of the stroller frame are pivotally and lockably connected by the pivot joint.

The two pivot joints mounted on the left side and the right side each may include a pivot mount, a first driving plate, a second driving plate and a locking mechanism. The pivot mount is connected at the upper end of the rear strut.

The first driving plate is pivoted to the pivot mount via a first axle and being connected to the rear upper end of the front strut and formed with a guiding slot.

The second driving plate is pivoted to the pivot mount via a second axle and being connected to the lower end of the push arm and mounted with a first stud protruded from one side thereof for slidably protruding into and engaging with the guiding slot.

The locking mechanism is operatively mounted on the upper end of the rear strut for locking the first driving plate and the second driving plate in a locked position, so as to keep the stroller frame in a deployed configuration for transport a baby or child occupant.

A release mechanism is associated between the locking mechanisms of the two pivot joints for unlocking the locking mechanisms simultaneously. Once the two pivot joints are unlocked by the release mechanism, the stroller frame can be safely folded into a folded configuration through the folding process.

According to the present invention, the structure of the stroller frame shall be simplified by embodying the pivot joints, this would cost-down and simply the process of manufacturing the stroller. Besides, the folding of the stroller frame according to the present invention can be actuated by merely using one hand to pull a middle driving element (such as a belt or the like) so as to unlock the pivot joints on the left and right sides simultaneously, and then the user can simply rotate the push arm downward, this rotation can make the front strut to rotate in opposite direction to close to the rear strut automatically.

### BRIEF DESCRIPTION OF THE DRAWINGS

The accompanying drawings, which are included to provide a further understanding of the invention are incorporated in and constitute a part of this specification, illustrate embodiments of the invention and together with the description serve to explain the principles of the invention. In the drawings:

FIG. 1 is a perspective view of the pivot joint mounted on a stroller frame according to the present invention.

FIG. 2 is a side view of the pivot joint mounted on a stroller frame according to the present invention.

FIG. 3 is an exploded view of the pivot joint according to the present invention.

FIG. 4 is a cross-sectional view illustrating the pivot joint has been locked the stroller frame in a deployed configuration (as which shown in FIGS. 1 and 2).

FIG. 5 is a cross-sectional view illustrating a folding process of the stroller frame while the pivot joint has been unlocked and the push arm is rotatable in a direction opposite to the rotation of the front strut.

FIG. 6 is a cross-sectional view illustrating a folding process of the stroller frame while the pivot joint has been unlocked and the push arm is rotatable in a direction opposite to the rotation of the front strut.

FIG. 7 is a cross-sectional view illustrating the folding process of the stroller frame has been reached a folded configuration.

### DETAILED DESCRIPTION OF THE PREFERRED EMBODIMENTS

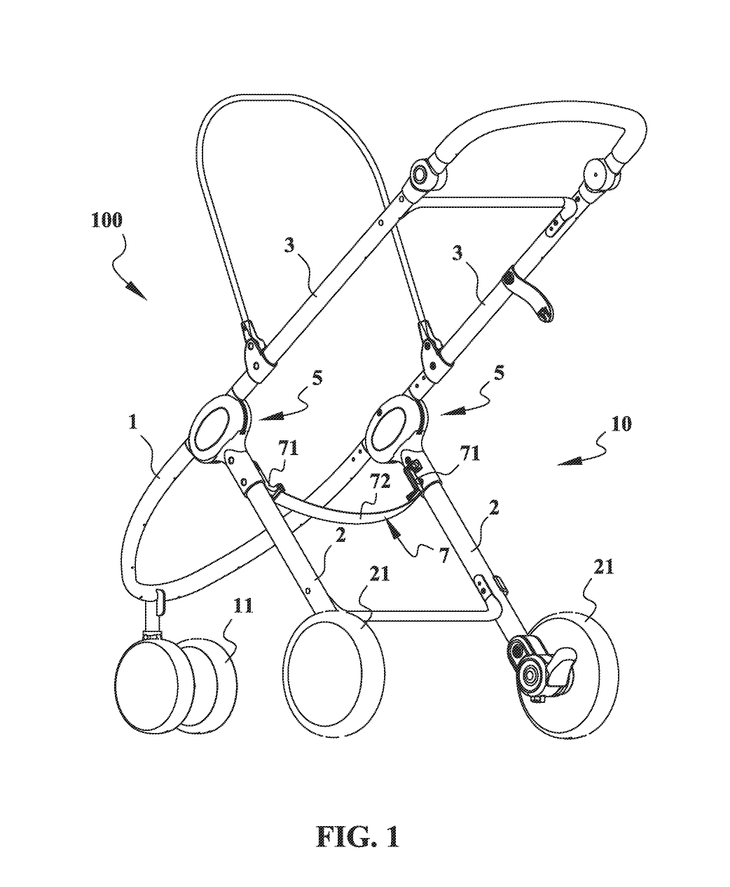

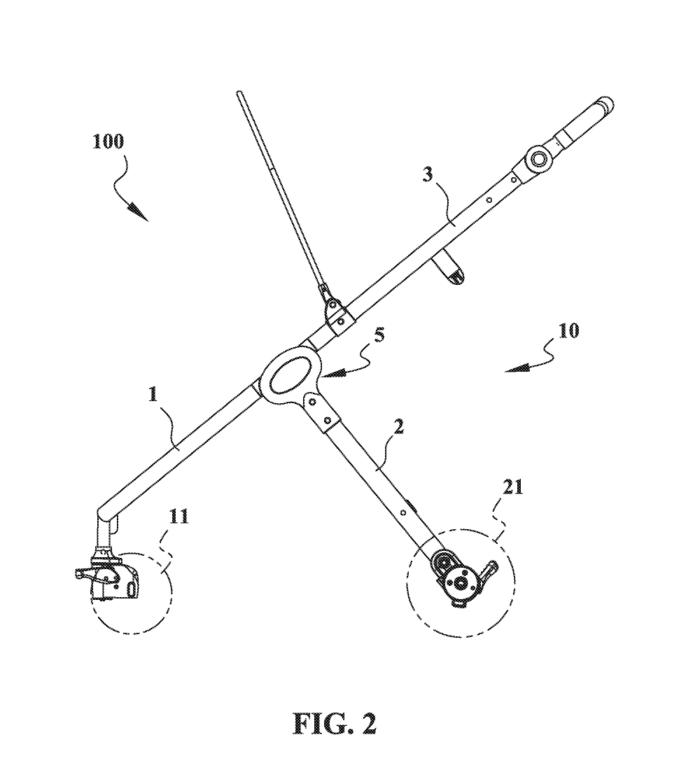

Referring to FIGS. 1 to 2, an embodiment of the pivot joint is applicable to a stroller frame according to the present invention. The stroller frame 10 includes a left side and a right side, each side comprising a front strut 1 connected at least a front wheel 11, a rear strut 2 connected a pair of rear wheels 21 and a push arm 3. The front strut 1, rear strut 2 and the push arm 3 of each side of the stroller frame 10 are pivotally and lockably connected by the pivot joint 5 according to the present invention.

The two pivot joints 5 are mounted on the left side and the right side of the stroller frame 10 respectively, each includes a pivot mount 51, a first driving plate 52, a second driving plate 53 and a locking mechanism 4. In this embodiment, the pivot mount 51 is connected at the upper end of the rear strut 2.

The first driving plate 52 is pivoted to the pivot mount 51 via a first axle 61 and being connected to the rear upper end of the front strut 1 and formed with a guiding slot 57.

The second driving plate 53 is pivoted to the pivot mount 51 via a second axle 62 and being connected to the lower end of the push arm 3 and mounted with a first stud 55 protruded from one side thereof for slidably protruding into and engaging with the guiding slot 57 of the first driving plate 52.

The locking mechanism 4 is operatively mounted on the upper end of the rear strut 2 for locking the first driving plate 52 and the second driving plate 53 in a locked position, so as to keep the stroller frame 10 in a deployed configuration 100 for transport a baby or child occupant.

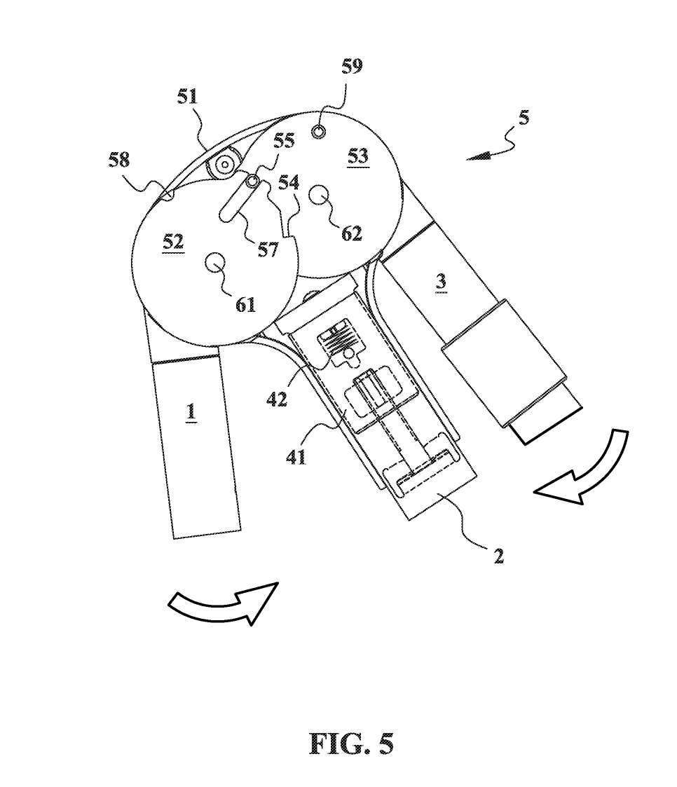

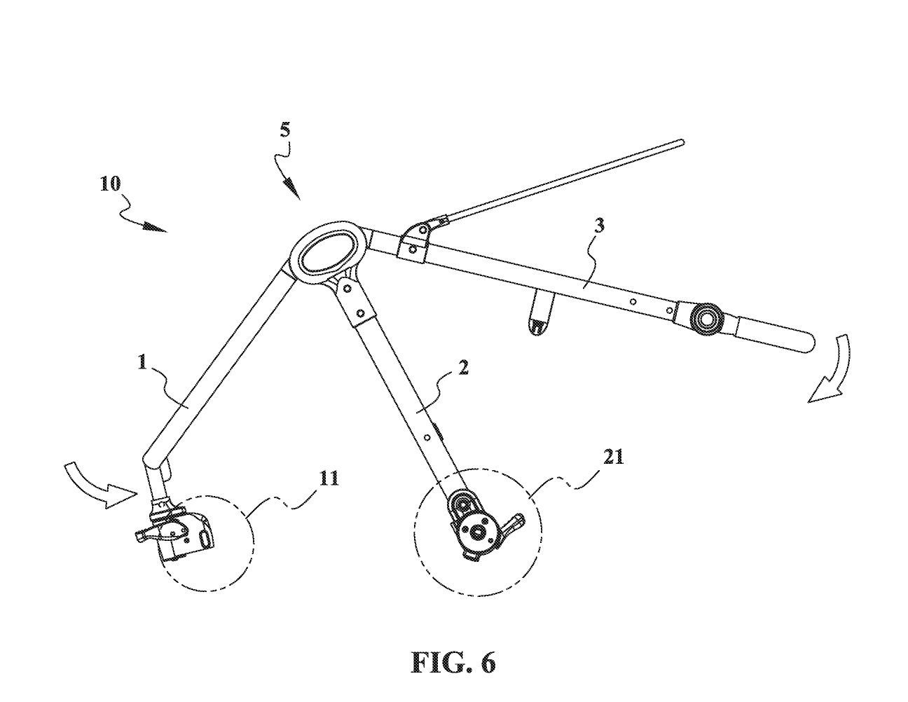

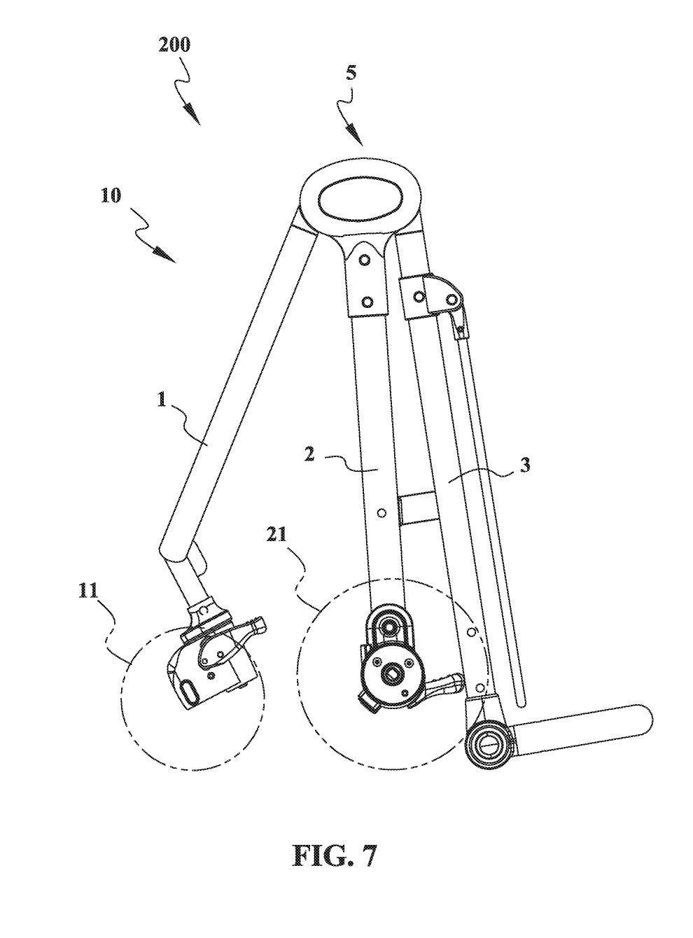

A release mechanism 7 is associated between the locking mechanisms 4 of the two pivot joints 5 for unlocking the locking mechanisms 4 simultaneously. Once the two pivot joints 5 are unlocked by the release mechanism 7, the stroller frame 10 can be safely folded into a folded configuration 200 as shown in FIG. 7 through the folding process illustrated in FIGS. 5 to 6.

Referring to FIGS. 5 to 6, as the second driving plate 53 is connected to the lower end of the push arm 3, the second driving plate 53 can be rotated by rotating the push arm 3. Once the second driving plate 53 is rotated, shall cause the first stud 55 to moving along and push against the guiding slot 57, this would force the first driving plate 52 and the front strut 1 to rotate in a direction opposite to the rotation of the second driving plate 53 and the push arm 3. By this way, the user may fold the stroller frame 10 merely by depressing the upper end of the push arm 3 to rotate downward, the front strut 1 would rotate reward to close to the rear strut 2 in the same time, and then to reach the folded configuration 200 as shown in FIG. 7.

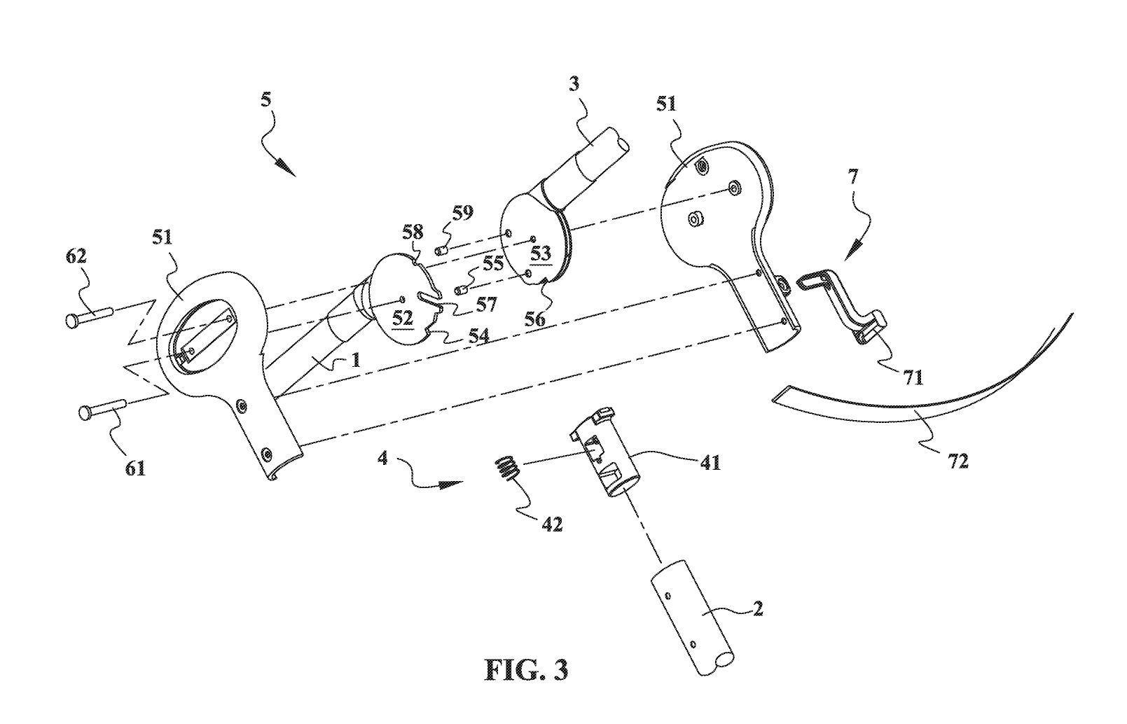

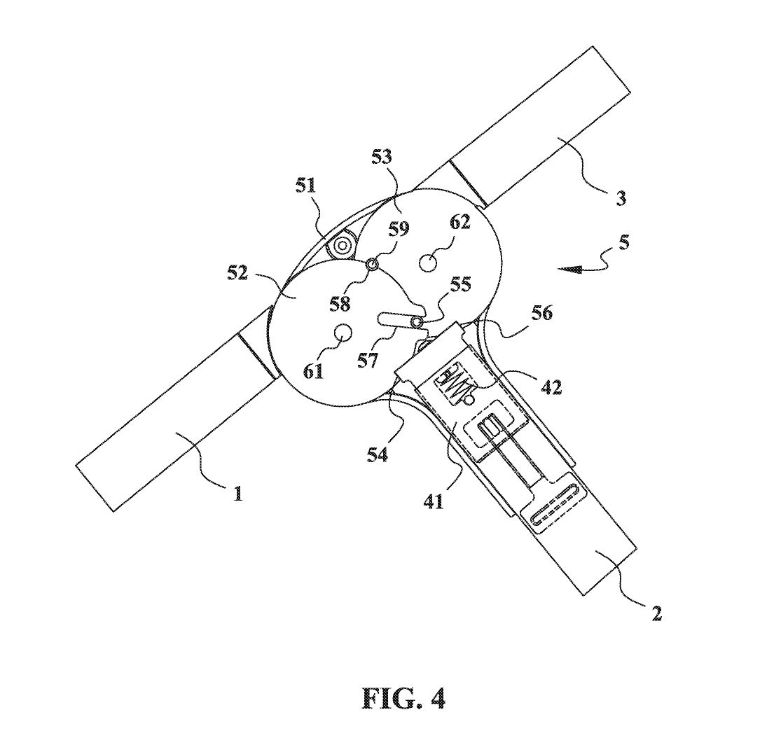

Referring to FIGS. 3 to 4, the locking mechanism 4 may include a latch element 41 associated with the release mechanism 7 and biased by a resilient element 42 so as kept to engage with the first driving plate 52 and the second driving plate 53 in the locked position. Preferably, the first driving plate 52 may further be formed with a first engagable portion 54, such as embodied as an indent, for engaging with the latch element 41 in the locked position. Similarly, the second driving plate 53 may also be formed with a second engagable portion 56, such as embodied as an indent, for engaging with the latch element 41 in the locked position.

Referring to FIGS. 1 and 3, the release mechanism 7 may include two side driving elements 71 each has one end engaged with the latch element 41, and another end connected with a middle driving element 72. The middle driving element 72 can use to drive the two latch elements 41 simultaneously to move against the biasing of the resilient element 42 so as to unlock the two pivot joints 5 mounted on the left side and the right side of the stroller frame 10.

Preferably, the middle driving element 72 may be embodied a flexible element, such as a belt or the like, with one end connected to the latch element 41 of the pivot joints 5 mounted on the left side of the stroller frame 10, and another end connected to the latch element 41 of the pivot joints 5 mounted on the right side of the stroller frame 10.

In this embodiment, the side driving elements 71 may be pivoted on the pivot mount 51, and drives the latch element 41 by rotation, when user pulled the middle driving element 72.

It is also preferably, the second driving plate 53 may further mounted with a second stud 59 protruded from one side for abutting against the first driving plate 52 when the stroller frame 10 is rotated and reached to the deployed configuration 100. In this embodiment, the first driving plate 52 may further be formed with an indent 58 for positioning the second stud 59, so as to enhance the stability of the operation.

The structure of the stroller frame 10 shall be simplified by embodying the pivot joints 5 according to the present invention. The folding of the stroller frame 10 can be actuated by merely using one hand to pull the middle driving element 72 (such as a belt or the like) to unlock the pivot joints 5 on the left and right sides simultaneously, and then the user can simply rotate the push arm 3 downward, this rotation can make the front strut 1 to rotate in opposite direction to close to the rear strut 2 automatically.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A pivot joint for a stroller frame, the stroller frame (10) having a left side and a right side each comprising a front strut (1), a rear strut (2) and a push arm (3) pivotally and lockably connected by a pivot joint (5); wherein the two pivot joints (5) each including:
a pivot mount (51), connected at an upper end of the rear strut (2);
a first driving plate (52), connected at an rear upper end of the front strut (1) and formed with a guiding slot (57), the first driving plate (52) having a first axle (61) for pivoting to the pivot mount (51);
a second driving plate (53), connected at a lower end of the push arm (3) and mounted with a first stud (55) protruded from one side thereof for slidably protruding into and engaging with the guiding slot (57) and having a second axle (62) for pivoting the second driving plate (53) to the pivot mount (51);
a locking mechanism (4), operatively mounted on the upper end of the rear strut (2) for locking the first driving plate (52) and the second driving plate (53) in a locked position; and
wherein the locking mechanisms (4) of the two pivot joints (5) are associated by a release mechanism (7), and the release mechanism (7) is capable of unlocking the locking mechanisms (4) simultaneously.

2. The pivot joint for a stroller frame according to claim 1, wherein the stroller frame (10) can be kept in a deployed configuration (100) by locking the two pivot joints (5) in the same time.

3. The pivot joint for a stroller frame according to claim 1, wherein the stroller frame (10) can be folded into a folded configuration (200) by unlocking the two pivot joints (5).

4. The pivot joint for a stroller frame according to claim 1, wherein the second driving plate (53) can be rotated by a rotation of the push arm (3), thereby driving the first driving plate (52) to rotate in an opposite direction by having the first stud (55) moving along and push against the guiding slot (57) thereby driving the front strut (1) to rotate in opposite direction of the rotation of the push arm (3).

5. The pivot joint for a stroller frame according to claim 1, wherein the locking mechanism (4) includes a latch element (41) associated with the release mechanism (7) and biased by a resilient element (42) so as kept to engage with the first driving plate (52) and the second driving plate (53) in the locked position.

6. The pivot joint for a stroller frame according to claim 5, wherein the first driving plate (52) is formed with a first engagable portion (54) for engaging with the latch element (41) in the locked position.

7. The pivot joint for a stroller frame according to claim 5, wherein the first engagable portion (54) is an indent formed on an edge of the first driving plate (52).

8. The pivot joint for a stroller frame according to claim 5, wherein the second driving plate (53) is formed with a second engagable portion (56) for engaging with the latch element (41) in the locked position.

9. The pivot joint for a stroller frame according to claim 5, wherein the second engagable portion (56) is an indent formed on an edge of the second driving plate (53).

10. The pivot joint for a stroller frame according to claim 5, wherein the release mechanism (7) includes two side driving elements (71) each having one end engaged with the latch element (41), and another end connected with a middle driving element (72); wherein the middle driving element (72) can drive the two latch elements (41) simultaneously to move against biasing of the resilient element (42), thereby unlocking the two pivot joints (5).

11. The pivot joint for a stroller frame according to claim 10, wherein the middle driving element (72) is a flexible element.

12. The pivot joint for a stroller frame according to claim 10, wherein the middle driving element (72) is a belt.

13. The pivot joint for a stroller frame according to claim 10, wherein each of the side driving elements (71) is pivoted on the pivot mount (51), and capable of driving the latch element (41) by rotation.

14. The pivot joint for a stroller frame according to claim 1, wherein the second driving plate (53) further mounted with a second stud (59) protruded from one side thereof for abutting against the first driving plate (52) when the stroller frame (10) is rotated to a deployed configuration (100)

15. The pivot joint for a stroller frame according to claim 1, wherein the first driving plate (52) is formed with an indent (58) for positioning the second stud (59).
